(19) United States
(12) Patent Application Publication
(10) Pub. No.: US 2025/0131173 A1
(43) Pub. Date: Apr. 24, 2025

(54) CIRCUIT VARIATION ANALYSIS USING INFORMATION SHARING ACROSS DIFFERENT SCENARIOS

(71) Applicant: Synopsys, Inc., Sunnyvale, CA (US)

(72) Inventors: Yanqing Chen, Shanghai (CN); Mohamed Baker Alawieh, Austin, TX (US); Han-Sen Dai, Fremont, CA (US); Kishore Singhal, Milpitas, CA (US)

(21) Appl. No.: 18/661,471

(22) Filed: May 10, 2024

Related U.S. Application Data
(63) Continuation of application No. PCT/CN2023/125794, filed on Oct. 20, 2023.

(51) Int. Cl. G06F 30/3308; G06F 30/3323

(52) U.S. Cl. CPC G06F 30/3308; G06F 30/3323

(57) ABSTRACT

Simulations of a circuit are performed for many different scenarios. These simulations are subject to statistical variations and the simulations produce preliminary analyses of the circuit for the different scenarios. A full characterization of the circuit is estimated for a scenario of interest, by migrating a full characterization for a reference scenario from the reference scenario to the scenario of interest. The full characterization for the reference scenario was produced by additional simulations of the circuit under the reference scenario. The reference scenario may be identified by grouping the different scenarios into clusters.

### RELATED APPLICATION

This application is a continuation of International Application No. PCT/CN2023/125794, “Circuit Variation Analysis Using Information Sharing Across Different Scenarios,” filed Oct. 20, 2023. The subject matter of all of the foregoing is incorporated herein by reference in its entirety.

### TECHNICAL FIELD

The present disclosure relates to the characterization of integrated circuits.

### BACKGROUND

The complexity of advanced integrated circuits (IC) has exacerbated the impact of process variations introduced throughout the IC manufacturing process. These variations are statistical in nature and result in random deviations from the intended behavior of the design. At the same time, optimizing the designs for performance, power, and area (PPA) combined with the push for ultra-low voltage designs has resulted in smaller design margins and higher sensitivity to these statistical variations.

Variation analysis characterizes the response of a given design considering these statistical variations. One goal is to estimate the probability distribution of the response of interest. This can then be used for yield analysis, design optimization, logic synthesis, etc. One example application is standard cells characterization. Standard cells are the building blocks for ASIC designs. They can have a very high replication rate, with millions of instances of a given cell appearing in a design. As a result, they must function correctly over a wide range of process and operating conditions. With this high replication rate, the responses of each of the cell instances can vary significantly because of statistical variations. Hence, characterizing the response at a high sigma value (i.e., modeling the extreme tails of the probability distribution of the response) for many different scenarios is important for building robust designs.

### SUMMARY

In some aspects, simulations of a circuit are performed for many different scenarios. These simulations are subject to statistical variations and the simulations produce preliminary analyses of the circuit for the different scenarios. A full characterization of the circuit is estimated for a scenario of interest, by migrating a full characterization previously produced for a reference scenario from the reference scenario to the scenario of interest. The full characterization for the reference scenario may be produced by additional simulations of the circuit beyond the preliminary analysis. Reference scenarios may be identified by grouping the different scenarios into clusters.

In other aspects, a database stores previously evaluated scenarios, including the preliminary analyses and full characterizations for those scenarios. Simulations of unevaluated scenarios are performed to produce preliminary analyses for the unevaluated scenarios. The database is accessed to identify reference scenarios for the unevaluated scenarios from among the evaluated scenarios, based on similarity of the preliminary analyses of the unevaluated scenarios with preliminary analyses of the evaluated scenarios. If a reference scenario is identified, the full characterization for the reference scenario is migrated to estimate the full characterization for the unevaluated scenario. If a reference scenario is not identified, additional simulations of the circuit are performed under the unevaluated scenario. The unevaluated scenario, preliminary analysis and full characterization may be stored in the database for future reference. The unevaluated scenarios may be processed in an order that increases a probability of identifying reference scenarios for unevaluated scenarios.

Other aspects include components, devices, systems, improvements, methods, processes, applications, computer readable mediums, and other technologies related to any of the above.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a diagram for multi-scenario variation analysis, in accordance with some embodiments of the present disclosure.

FIG. 2 is another diagram for multi-scenario variation analysis, in accordance with some embodiments of the present disclosure.

FIG. 3 is yet another diagram for multi-scenario variation analysis, in accordance with some embodiments of the present disclosure.

FIG. 4 is a block diagram of a system for multi-scenario variation analysis, in accordance with some embodiments of the present disclosure.

FIG. 5 depicts a flowchart of various processes used during the design and manufacture of an integrated circuit in accordance with some embodiments of the present disclosure.

FIG. 6 depicts a diagram of an example computer system in which embodiments of the present disclosure may operate.

### DETAILED DESCRIPTION

Aspects of the present disclosure relate to circuit variation analysis using information sharing across different scenarios. Variation analysis characterizes the response of a given circuit design across many different scenarios, considering statistical variations for each scenario.

The traditional approach to variation analysis involves running Monte Carlo simulations to model the statistical variations. To cover a desired tail region at a given standard deviation (sigma) requirement for a specific scenario, a sufficient number of simulations must be run under that scenario to produce enough samples within the tail region for that scenario. For higher sigma tail regions, more samples need to be run. In a typical multi-scenario analysis framework, the number of scenarios (e.g., corners) can range between a few tens to thousands. Standard cells may be characterized at many different process, voltage and temperature conditions because they can be used in many designs with different operating conditions. In such a flow, a design is usually characterized independently at each scenario under consideration with the goal of capturing the high sigma tail region of the response distribution. As both the number of scenarios and the target sigma increase, the computational cost for variation characterization can quickly become prohibitively expensive.

While the response of a design differs from one scenario to another, the behavior under different scenarios is often similar. As a result, knowledge acquired from the characterization of one scenario can be used to speed up the characterization of other similarly behaving scenarios. Treating the characterization of different scenarios as independent, unrelated tasks overlooks the opportunity to share information across scenarios and reduce redundant effort.

In some aspects, information is shared between different scenarios to speed up the multi-scenario variation analysis of a circuit design. The sharing of information from the characterization of earlier scenarios can accelerate the characterization of subsequent scenarios. Given that behavior under different scenarios can be similar, information sharing can avoid costly cold starts by providing the accumulated knowledge from previous similar scenarios as a starting point for each new scenario. The prior information can be fused with a small number of simulations under the new scenario to migrate the knowledge to the new scenario and proceed with any additionally needed steps to complete the characterization.

Technical advantages of the present disclosure include, but are not limited to, the following. The computational cost of completing the multi-scenario variation analysis can be reduced. A full characterization analysis need not be run for every scenario. Rather, the characterization of later-evaluated scenarios may be based on the full characterizations of earlier-evaluated similar scenarios, which are then migrated to the current scenario of interest.

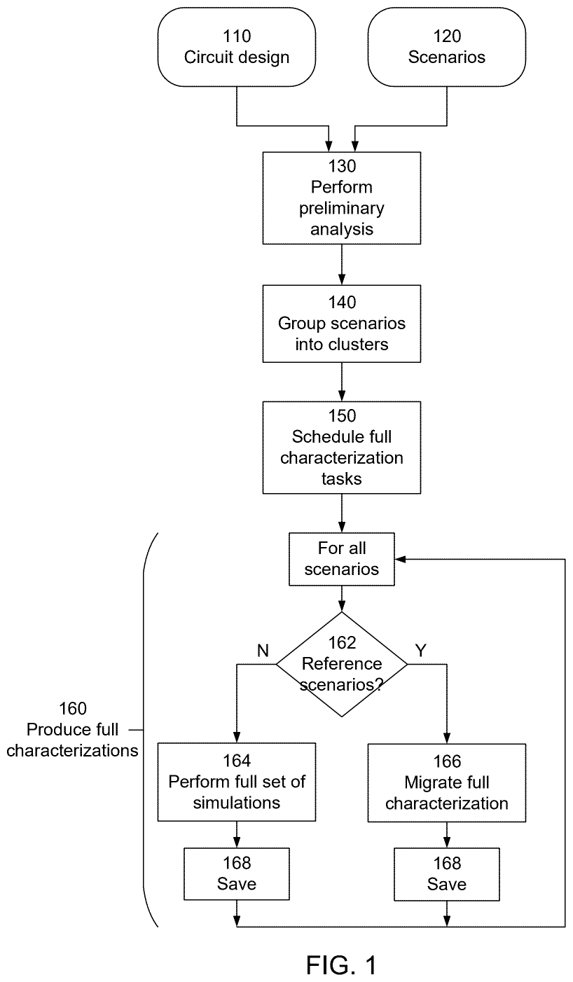

FIG. 1 is a flow diagram for performing multi-scenario variation analysis of a circuit design. A circuit design 110 is to be evaluated under many different scenarios 120. The different scenarios may include different corners, including different process conditions, different voltage conditions, and different temperature conditions. They may also include different signal patterns (e.g., different input test signals) and different load conditions. Another example of different scenarios is implementations of the circuit using different devices, for example using low threshold transistors versus high threshold transistors. These scenarios may be referred to as different testbenches. For convenience, these different variations are referred to as different scenarios.

The flow of FIG. 1 characterizes the circuit under these different scenarios. Different characteristics may be evaluated. For example, characterization may include estimating metrics for timing delay, hold margin, noise level, and voltage variation. The purpose of the characterization may be standard cell variation characterization, multi-corner standard cell variation characterization, standard cell robustness check, or general multi-corner multi-testbench variation analysis.

The scenarios exhibit statistical variations. For a given scenario, the metric of interest may vary according to some probability distribution. The characterization of FIG. 1 accounts for this statistical variation. For example, the result of the characterization may be an estimate of a high sigma value for the metric of interest considering these statistical variations and under all scenarios.

FIG. 1 proceeds as follows. At 130, simulations of the circuit are performed to produce preliminary analyses of the circuit for the different scenarios. In one approach, this is achieved by running a small number of Monte Carlo simulations under each scenario. The number of simulations is not sufficient to produce the full characterization desired, but it is sufficient to determine whether different scenarios behave similarly. To facilitate comparison of these simulations in later step 140, the same seeds may be used for the simulations of different scenarios. In addition, to reduce the number of simulations used to produce a good preliminary analysis, the distribution of the simulations may be designed to provide a good sampling of the probability distribution of interest rather than relying on a purely random selection of samples.

At 140, the different scenarios 120 are grouped into clusters, based on the preliminary analyses produced at 130. This clustering will be used later to determine which scenarios share information. Using the results from the preliminary simulations 130, the similarity in behavior between different scenarios can be quantified. The small number of samples can be used to compare the performance of different scenarios and evaluate the similarity in behavior under statistical variation. This can be used to calculate a similarity metric (e.g., correlation between simulation results across different scenarios). The preliminary analysis 130 provides a data-driven clustering scheme that does not require any information about the design or the scenarios.

In cases where physical information or other metadata about the scenarios is available, that may also be used for clustering. For example, a multi-corner setup can have different corners defined by varying the load condition, voltage, and temperature. If each of these parameters can take one of three values (min, nominal, max), this information can be used as a similarity metric. Table 1 below shows three corners and their corresponding parameters. The metadata indicates that corners 1 and 2 have higher similarity than corners 1 and 3.

TABLE 1
Scenario parameters indicate similarity.

| | Load condition | Voltage | Temperature |
|---|---|---|---|
| Corner 1 | Min | Min | Min |
| Corner 2 | Min | Min | Nominal |
| Corner 3 | Max | Max | Max |

Physical information can also include device level information (e.g. threshold voltage) or other characteristics of the design and/or the scenario that can be used to evaluate similarity between different scenarios. Therefore, a quantitative similarity metric can be computed based on this metadata.

The similarity based on scenario metadata can augment the similarity based on the preliminary analyses. Given the similarity metrics, the clustering step 140 groups scenarios into clusters. Scenarios in the same cluster are determined to be good candidates to benefit from information sharing. The number of clusters need not be pre-defined. It can be determined dynamically. The number of clusters can be obtained using various methods, including minimum within cluster similarity requirement, maximum cluster merging distance, and dynamic clustering cutoffs methods (e.g., elbow method). In addition, available computational resources and scheduling considerations can also be factored into the clustering step.

In some implementations, the clustering step 140 selects one or more anchor scenarios for each cluster. In one approach, the anchor scenario is the base scenario for the cluster, and the other scenarios in the cluster are evaluated relative to the anchor scenario (and possibly also other scenarios in the cluster). In such a case, the full characterization of the anchor scenario may be completed first, before the full evaluation of the other scenarios in the cluster. As a result, the full characterization of the anchor scenario will be available when evaluating the other scenarios. In one approach, the evaluation of later scenarios in a cluster uses information from the anchor scenario and all other previously evaluated scenarios in the cluster. It is also possible to limit the sharing in each cluster to be between the anchor scenario and the current scenario of interest, without using information from non-anchor scenarios in the cluster.

At 150, the full characterizations for the different scenarios are scheduled. The clustering information from step 140 may be used in scheduling. For example, if anchor scenarios are identified, then those may be scheduled for full characterization before other scenarios in the same cluster. In addition, priority may be given to clusters for which no full characterizations have yet been estimated. These approaches increase the probability that a later evaluated scenario in a cluster will be similar to a previously evaluated scenario, so that information from the previous full characterization may be reused.

For example, assume that the number of tasks (T) in a multi-corner analysis is much larger than the number of available cores (C). Here, each task is the full characterization of one of the scenarios. This means that not all T characterization tasks may be performed in parallel and some scenarios will be evaluated after others. When T>>C, the clustering information from 140 provides a dependency that can be used in the scheduler. As an example, consider a case with 10 clusters, each containing 10 tasks (scenarios), and 10 available CPUs. The tasks are run in batches. For each batch, each CPU executes one of the tasks. A schedule with good information reuse is to include in each batch one task from each cluster. At each batch b, information from b−1 previous tasks from each cluster is available to be used by task b. This allows for the maximum information reuse while still ensuring full utilization of resources. On the other hand, a schedule with poor information reuse is to run all tasks from a cluster in the same batch. When all similar scenarios are evaluated in parallel, minimal information sharing is possible.

Therefore, the scheduler uses the clustering scheme and the information about available resources to schedule characterization tasks with the objective of maximizing both information reuse and resource utilization.

At 160, the full characterizations of the scenarios are produced. This step performs the full characterization tasks for all scenarios by leveraging the information sharing scheme set up by the clustering step 140. At 162, it is determined whether full characterizations have already been completed for other scenarios that are similar to the current scenario of interest. These previously evaluated scenarios will be referred to as reference scenarios. Anchor scenarios are an example of reference scenarios.

If no reference scenarios exist, then at 164 the full characterization is performed for the scenario of interest. For example, this might include running a set of Monte Carlo simulations for the scenario, augmented by predictions from machine learning models.

If a reference scenario(s) exists, then at 166 the full characterization for the current scenario is determined by reusing information from the full characterization of the reference scenario. This is referred to as migrating the full characterization from the reference scenario to the current scenario.

As an example using anchor scenarios, at the beginning of 160, all the scenarios in a cluster have not yet been fully evaluated. Of these unevaluated scenarios, the anchor scenario is the first scenario to be fully characterized. Additional simulations are run to complete the Monte Carlo-based characterization (branch 164). These results are stored in a database. The information store may include simulation results, simulation seeds, tail samples information, machine learning models, model predictions, etc.

For later scenarios, step 162 determines that a reference scenario is available. It is the previously evaluated anchor scenario. This determination may be based on similarity of the preliminary analyses. Alternatively, since the clusters were formed based on the similarity of preliminary analyses, the determination may be based on cluster membership. Branch 166 then estimates the full characterizations for these later scenarios, by migrating the full characterization of the anchor scenario to the scenario of interest. As more full characterizations are completed, they may be stored to the database at 168 for reuse with later scenarios. In some cases, only the full characterizations produced by the original Monte Carlo simulations (branch 164) are stored.

The following are some examples of migrating the shared information from one scenario to another. At the start of the full characterization of the new scenario, the information stored for the reference scenario(s) in the cluster are loaded and migrated to the scenario under analysis. The migrated information gives the new scenario a quick start where useful data is available at zero or minimal simulation cost.

In many cases, the process for estimating the full characterization for a scenario relies on machine learning algorithms to reduce the number of simulations required to complete the task. State-of-the-art machine learning methods provide a wide range of methods to repurpose a model to work on a similar task. The original model is trained using a large dataset in its native setup (e.g., the full simulation for the reference scenario) and is tuned using a very small number of samples in the new setup (i.e., for the current scenario of interest).

These methods include Bayesian methods and transfer learning. Bayesian methods may be used to combine prior information with limited information from the current scenario to reduce the modeling cost. Transfer learning may be used to migrate models across different scenarios by using a small number of simulations. Multi-scenario machine learning models are another approach. These may be built and dynamically updated. For example, a machine learning model may be built to make predictions for different scenarios within a cluster. These methods reduce the number of training samples (simulations) used to build models for the evaluation of new scenarios.

Results, including sample ordering, simulation output, samples in tail, etc., may be migrated from one scenario to another. For example, the tail region discovered for one scenario may be migrated to another scenario. In one approach, the migration is implemented by identifying the samples in the tail region (e.g., the simulation seeds) and migrating those to the new scenario. Samples may be migrated for other purposes also. Prediction results from machine learning models may also be migrated using a small number of new samples/predictions. These techniques can be used to refine models, select optimal samples to simulate, etc.

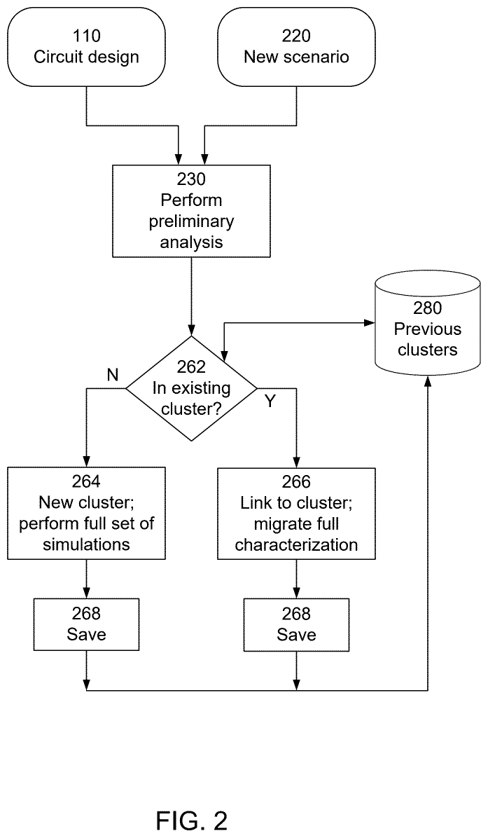

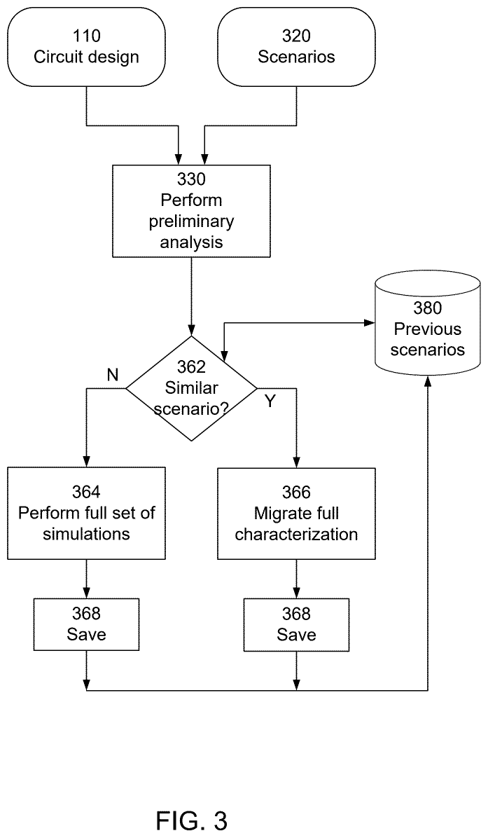

Some use models may use only a subset of the techniques described in FIG. 1 or may use variations of those techniques. Two alternative use models are discussed below with respect to FIGS. 2 and 3.

FIG. 2 shows a use case where the flow of FIG. 1 is completed for an initial set of scenarios, and additional scenarios are added later for evaluation. Database 280 stores the results from the initial processing of scenarios. This includes the clustering, as well as the characterizations of the different scenarios. FIG. 2 shows the flow for evaluating a new scenario 220. At 230, the preliminary analysis for the new scenario is produced. At 262, it is determined whether the new scenario belongs to one of the previously defined clusters, based on preliminary analysis of the new scenario. In other words, the system checks if the new scenario is similar to already evaluated scenarios. If the new scenario belongs to an existing cluster, at 266 it will be linked to that cluster and prior information from the cluster is used for the full characterization of the new scenario. Otherwise, if the new scenario is not similar to any of the prior clusters, at 264 a new single-member cluster with the new scenario is created and the full characterization is performed without information reuse. The addition of the new cluster to the database 280 allows even later scenarios to reuse information from the new scenario. Hence, useful information is saved. If there are a large number of new scenarios to be evaluated, a hybrid of FIGS. 1 and 2 may be used. For example, a scheduler may be used after identifying which new scenarios belong to a new cluster.

In FIG. 3, the multi-scenario starts with very few scenarios, but other scenarios are added as time progresses. At 330, preliminary analyses are produced for the scenarios. In this case, there is no clustering or scheduling. Rather, at 362, each new scenario is compared to previously evaluated scenarios to determine which scenarios, if any, may serve as reference scenarios. If similar scenarios have been previously evaluated, at 366, the full characterization of the new scenario is performed with information reuse from those scenarios. If there are no similar scenarios, at 364, the full characterization of the new scenario is performed without information reuse. At 368, results for these new evaluations may be saved in database 380 for later reuse.

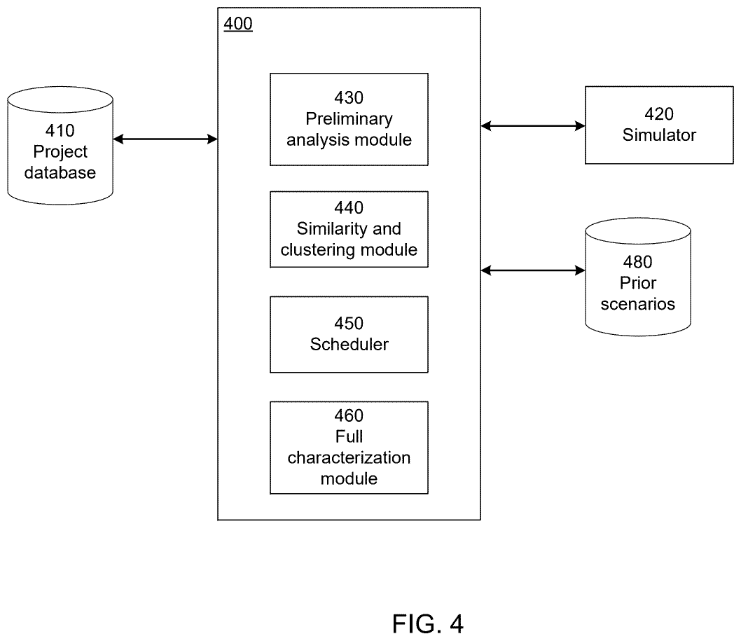

FIG. 4 is a block diagram of a system that may be used to implement the flows described herein. The system includes a project database 410, which includes the design and the scenarios being evaluated. The system also includes a simulator 420, which performs the Monte Carlo simulations. Database 480 stores information from previous evaluations. This can include the preliminary analyses to determine whether scenarios are similar, and the full characterizations to allow information reuse between similar scenarios. The software tool 400 includes the software modules that implement steps x30-x60 in FIGS. 1-3. Module 430 controls the simulator 420 to produce the preliminary analyses. Module 440 handles similarity comparisons of scenarios, including grouping scenarios into clusters if applicable. Module 450 is a scheduler that schedules the full evaluations of the different scenarios. Module 460 handles the production of the full characterizations. This includes determining whether information reuse is available, migrating information from other scenarios, and controlling the simulator 420 to run additional simulations as needed.

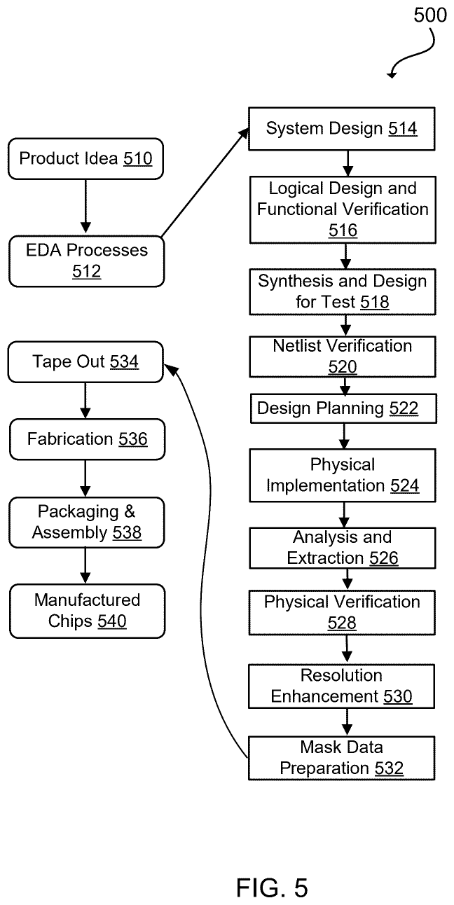

FIG. 5 illustrates an example set of processes 500 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 510 with information supplied by a designer, information which is transformed to create an article of manufacture that uses a set of EDA processes 512. When the design is finalized, the design is taped-out 534, which is when artwork (e.g., geometric patterns) for the integrated circuit is sent to a fabrication facility to manufacture the mask set, which is then used to manufacture the integrated circuit. After tape-out, a semiconductor die is fabricated 536 and packaging and assembly processes 538 are performed to produce the finished integrated circuit 540.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, SystemC, MyHDL or Open Vera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 5. The processes described by be enabled by EDA products (or EDA systems).

During system design 514, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 516, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 518, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 520, the netlist is checked for compliance with timing constraints and for correspondence with the HDL code. During design planning 522, an overall floor plan for the integrated circuit is constructed and analyzed for timing and top-level routing.

During layout or physical implementation 524, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 526, the circuit function is verified at the layout level, which permits refinement of the layout design. During physical verification 528, the layout design is checked to ensure that manufacturing constraints are correct, such as DRC constraints, electrical constraints, lithographic constraints, and that circuitry function matches the HDL design specification. During resolution enhancement 530, the geometry of the layout is transformed to improve how the circuit design is manufactured.

During tape-out, data is created to be used (after lithographic enhancements are applied if appropriate) for production of lithography masks. During mask data preparation 532, the ‘tape-out’ data is used to produce lithography masks that are used to produce finished integrated circuits.

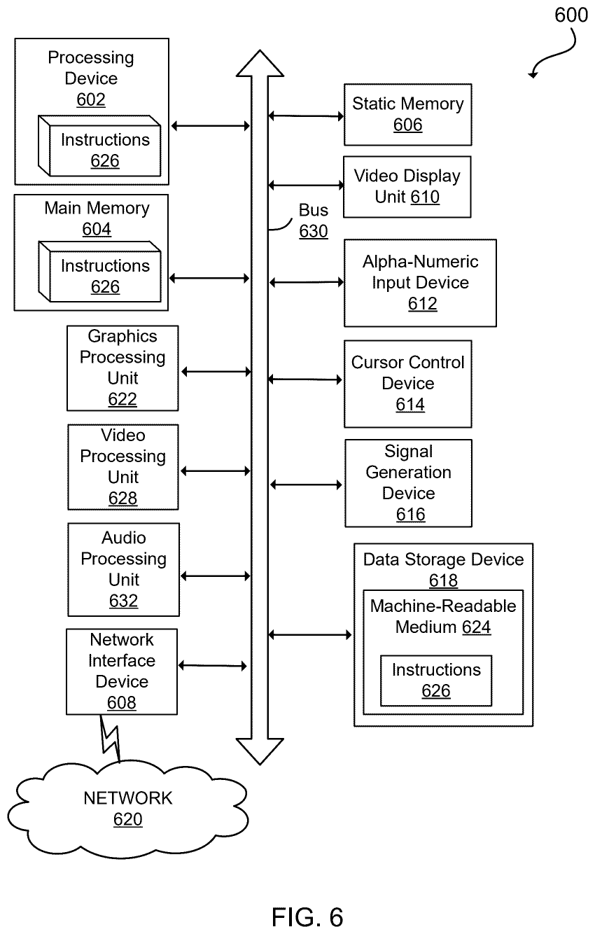

A storage subsystem of a computer system (such as computer system 600 of FIG. 6) may be used to store the programs and data structures that are used by some or all of the EDA products described herein, and products used for development of cells for the library and for physical and logical design that use the library.

FIG. 6 illustrates an example machine of a computer system 600 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM), a static memory 606 (e.g., flash memory, static random access memory (SRAM), etc.), and a data storage device 618, which communicate with each other via a bus 630.

Processing device 602 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 may be configured to execute instructions 626 for performing the operations and steps described herein.

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a non-transitory computer-readable medium) on which is stored one or more sets of instructions 626 or software embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In some implementations, the instructions 626 include instructions to implement functionality corresponding to the present disclosure. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 602 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
performing simulations of a circuit under a plurality of different scenarios to produce preliminary analyses of the circuit for the different scenarios, wherein the simulations are subject to statistical variations;
grouping the different scenarios into clusters, based on the preliminary analyses; and
estimating, by a processing device, a full characterization of the circuit for a first one of the scenarios, comprising: migrating, from a reference scenario to the first scenario, a full characterization for the reference scenario, wherein the reference scenario and first scenario are grouped in a same cluster, and the full characterization for the reference scenario was produced by additional simulations of the circuit.

2. The method of claim 1, wherein the different scenarios include at least one of: different process conditions, different voltage conditions, different temperature conditions, different input signal patterns, different load conditions, and implementations of the circuit using different devices.

3. The method of claim 1, wherein the full characterizations of the circuit include metrics for at least one of: a timing delay, a hold margin, a noise level, and a voltage variation.

4. The method of claim 1, wherein the full characterizations of the circuit include at least one of: a standard cell variation characterization, a multi-corner standard cell variation characterization, a standard cell robustness check, and a general multi-corner multi-testbench variation characterization.

5. The method of claim 1, wherein grouping the different scenarios into clusters is based on correlations between the preliminary analyses for the different scenarios.

6. The method of claim 1, wherein grouping the different scenarios into clusters is further based on metadata describing the different scenarios.

7. The method of claim 1, wherein grouping the different scenarios into clusters uses at least one of: a minimum within cluster similarity requirement, a maximum cluster merging distance, and a dynamic clustering cutoff method.

8. The method of claim 1, wherein migrating the full characterization for the reference scenario comprises: training and applying a multi-scenario machine learning model for the scenarios in the same cluster.

9. A non-transitory computer readable medium comprising stored instructions, which when executed by a processing device, cause the processing device to:
perform simulations of a circuit under a first scenario to produce a preliminary analysis of the circuit for the first scenario, wherein the simulations are subject to statistical variations;
identify a second scenario, based on similarity of the preliminary analysis of the first scenario with a preliminary analysis of the second scenario; and
estimate a full characterization of the circuit for the first scenario, comprising:
migrating a full characterization for the second scenario to the first scenario.

10. The non-transitory computer readable medium of claim 9, wherein migrating the full characterization for the second scenario to the first scenario comprises:
migrating, to the first scenario, samples used to produce the full characterization for the second scenario; and
performing additional simulations under the first scenario using the migrated samples.

11. The non-transitory computer readable medium of claim 9, wherein migrating the full characterization for the second scenario to the first scenario comprises:
migrating, to the first scenario, a machine learning model used to produce the full characterization for the second scenario.

12. The non-transitory computer readable medium of claim 11, wherein migrating the machine learning model uses at least one of: a Bayesian method, and transfer learning.

13. The non-transitory computer readable medium of claim 9, wherein migrating the full characterization for the second scenario to the first scenario comprises:
migrating, to the first scenario, a tail region of the statistical variations for the second scenario.

14. The non-transitory computer readable medium of claim 9, wherein migrating the full characterization for the second scenario to the first scenario comprises:
migrating, to the first scenario, results of simulations used to produce the full characterization for the second scenario.

15. The non-transitory computer readable medium of claim 9, further comprising:
validating the estimate of the full characterization for the first scenario.

16. A system comprising:
a database configured to store evaluated scenarios for operation of a circuit, corresponding preliminary analyses of the circuit for the evaluated scenarios, and corresponding full characterizations of the circuit for the evaluated scenarios; wherein the characterizations for the evaluated scenarios were produced by simulations of the circuit subject to statistical variations; and
a memory storing instructions, and a processing device coupled with the memory and to execute the instructions, the instructions when executed cause the processing device to:
perform simulations of the circuit under a plurality of unevaluated scenarios to produce preliminary analyses of the circuit for the unevaluated scenarios;
access the database to identify reference scenarios for the unevaluated scenarios from among the evaluated scenarios, based on similarity of the preliminary analyses of the unevaluated scenarios with preliminary analyses of the evaluated scenarios; and
estimate a full characterization of the circuit for the unevaluated scenarios, comprising:
for unevaluated scenarios where a reference scenario is identified, retrieving from the database and migrating the full characterization for the reference scenario to the unevaluated scenario; and
for unevaluated scenarios where a reference scenario is not identified, by performing additional simulations of the circuit under the unevaluated scenario, and storing the unevaluated scenario, preliminary analysis and full characterization in the database.

17. The system of claim 16, wherein estimating the full characterizations of the circuit for the unevaluated scenarios are scheduled in an order that increases a probability of identifying reference scenarios for unevaluated scenarios.

18. The system of claim 16, wherein the instructions when executed cause the processing device further to group the different scenarios into clusters based on the preliminary analyses; and estimating the full characterizations of the circuit for the unevaluated scenarios are scheduled in an order that gives priority to clusters for which no full characterizations have been estimated.

19. The system of claim 16, wherein the preliminary and full characterizations use Monte Carlo simulations, and the preliminary analysis uses a smaller number of Monte Carlo simulations than the full characterization.

20. The system of claim 19, wherein the preliminary analyses for different unevaluated scenarios use same seeds for the Monte Carlo simulation.
